(19) United States
(12) Patent Application Publication
(10) Pub. No.: US 2026/0187331 A1
(43) Pub. Date: Jul. 2, 2026

(54) Programmable Logic Device Embedded Block Power Control

(71) Applicant: Altera Corporation, San Jose, CA (US)

(72) Inventors: Martin Langhammer, Alderbury (GB); Ramnarayanan Muthukaruppan, Newark, CA (US); Dongdong Chen, San Jose, CA (US); Jeffrey Chromczak, Toronto (CA); Ilya Ganusov, San Jose, CA (US); Jason Bergendahl, Cupertino, CA (US)

(21) Appl. No.: 19/002,400

(22) Filed: Dec. 26, 2024

(51) Int. Cl. G06F 30/347; G06F 30/36; G06F 119/06

(52) U.S. Cl. CPC G06F 30/347; G06F 30/36; G06F 2119/06

(57) ABSTRACT

Integrated circuit devices, systems, machine-readable media, and methods are provided to reduce power consumption by supplying a lower voltage to an embedded application-specific integrated circuit (ASIC) block of a programmable logic device than an overall supply voltage while still achieving target performance. An integrated circuit device according this disclosure may include programmable logic circuitry configurable to be set to operate at a first voltage and a first ASIC block configurable to be set to operate at a second voltage different than the first voltage.

### BACKGROUND

This disclosure relates to controlling power supplied to embedded hardened application specific integrated circuit (ASIC) blocks, such as digital signal processing (DSP) blocks, of a programmable logic device.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuits are found in numerous electronic devices and provide a variety of functionality. Many integrated circuits include hardened ASIC blocks, such as DSP blocks, with arithmetic circuit blocks that may perform certain specialized operations more efficiently than other circuits. For example, a digital signal processing (DSP) block may supplement programmable logic circuitry in a programmable logic device, such as a field programmable gate array (FPGA) to perform certain arithmetic functions more efficiently than programmable logic circuitry alone. Yet DSP blocks, as well as other embedded ASIC blocks, are relatively large consumers of power. This may be due to the high functional density of these blocks compared to other programmable logic circuitry.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device;

FIG. 2 is a block diagram of the integrated circuit device of FIG. 1;

FIG. 3 is a flowchart of a method for configuring a voltage level of an embedded ASIC block of the integrated circuit device of FIG. 1;

FIG. 4 is a block diagram of a local voltage regulator associated with the embedded ASIC block of the integrated circuit device;

FIG. 5 is a block diagram of a power train to adjust a voltage of the embedded ASIC block of the integrated circuit device using spatially distributed 7-bit control;

FIG. 6 is an example control diagram and table corresponding to a 5-bit control signal; and

FIG. 7 is a block diagram of a data processing system that may incorporate an integrated circuit device according to this disclosure.

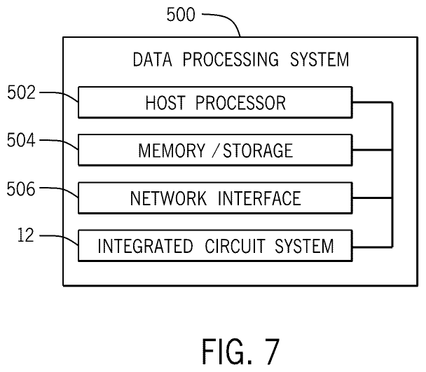

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Many integrated circuits, such as programmable logic devices, include embedded application specific integrated circuit (ASIC) blocks, such as digital signal processing (DSP) blocks. ASIC blocks such as DSP blocks include “hardened” circuits that are specialized to efficiently perform certain operations. This is in contrast to “soft logic” circuits that may be formed by programming programmable logic circuitry, but which may not be as efficient. Embedded ASIC blocks, such as DSP blocks, memory blocks, input/output circuitry, and network-on-chip (NOC) circuitry, may be comparatively large consumers of power. This may be due to the high functional density of these hardened blocks compared to the soft logic of the programmable logic circuitry.

As process nodes for manufacturing integrated circuit devices become more advanced, particularly for integrated circuits based on deep submicron technology, power consumption is increasingly dependent on voltage. Indeed, in smaller geometries, dynamic power is not simply a linear result of the clock frequency —the supply voltage is also a significant factor. This disclosure provides systems and methods to reduce power consumption by configurably reducing the voltage of embedded ASIC blocks, such as DSP blocks, to the extent that doing so does not preclude an FPGA system design from achieving a desired maximum frequency. For example, DSP blocks may be characterized at a particular voltage and may run at a particular clock frequency (e.g., 750 MHz to 1 GHz). Yet many FPGA system designs are a fraction of this speed (e.g., 200 MHz to 400 MHz). To reduce power consumption by the DSP blocks without affecting the operation of the FPGA system design, after timing closure, a voltage control circuit of the DSP block may be configured to reduce the DSP block voltage so that the DSP block still runs faster than the surrounding system design performance.

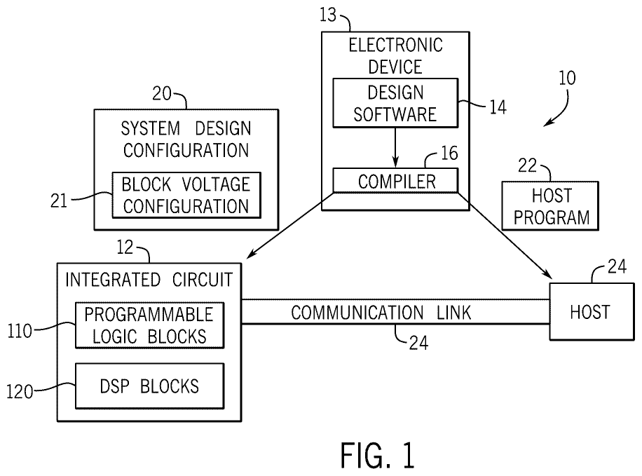

FIG. 1 illustrates a block diagram of a system 10 that may be used to implement the systems and methods of this disclosure on an integrated circuit device 12 (e.g., a single monolithic integrated circuit or a multi-die system of integrated circuits). A designer may desire to implement a system design on the integrated circuit device 12 (e.g., a programmable logic device such as a field-programmable gate array (FPGA) or an application-specific integrated circuit (ASIC) that includes programmable logic circuitry). The integrated circuit device 12 may include a single integrated circuit, multiple integrated circuits in a package, or multiple integrated circuits in multiple packages communicating remotely (e.g., via wires or traces) and may be referred to as an integrated circuit device whether formed from a single integrated circuit or multiple integrated circuits in a package. In some cases, the designer may specify a high-level program to be implemented, such as an OPENCL® program that may enable the designer to more efficiently and easily provide programming instructions to configure a set of programmable logic cells for the integrated circuit device 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

In a configuration mode of the integrated circuit device 12, a designer may use an electronic device 13 (e.g., a computer including a data processing system having a processor and memory or storage) to implement high-level designs (e.g., a system user design) using design software 14 (e.g., executable instructions stored in a tangible, non-transitory, computer-readable medium such as the memory or storage of the electronic device 13), such as a version of INTEL® QUARTUS® by INTEL CORPORATION. The electronic device 13 may use the design software 14 and a compiler 16 to convert the high-level program into a lower-level description (e.g., a configuration program, a bitstream). The compiler 16 may provide machine-readable instructions representative of the high-level program to a host 18 and the integrated circuit device 12. The integrated circuit device 12 may be configured using a system design configuration 20 (e.g., configuration bitstream, kernel program, circuit design, system design) that includes block voltage configurations 21 specifying supply voltage settings that define voltage levels for various circuit blocks of the integrated circuit device 12. The host 18 may receive a host program 22 that may control or be implemented by the system design configuration 20. To implement the host program 22, the host 18 may communicate instructions from the host program 22 to the integrated circuit device 12 via a communications link 24 that may include, for example, direct memory access (DMA) communications or peripheral component interconnect express (PCIe) communications. In some embodiments, the system design configuration 20 and the host 18 may configure programmable logic blocks (e.g., LABs 110) on the integrated circuit device 12. The programmable logic blocks (e.g., LABs 110) may include circuitry and/or other logic elements and may be configurable to implement a variety of functions in combination with digital signal processing (DSP) blocks 120.

The designer may use the design software 14 to generate and/or to specify a low-level program, such as the low-level hardware description languages described above. Further, in some embodiments, the system 10 may be implemented without a separate host program 22. Thus, embodiments described herein are intended to be illustrative and not limiting.

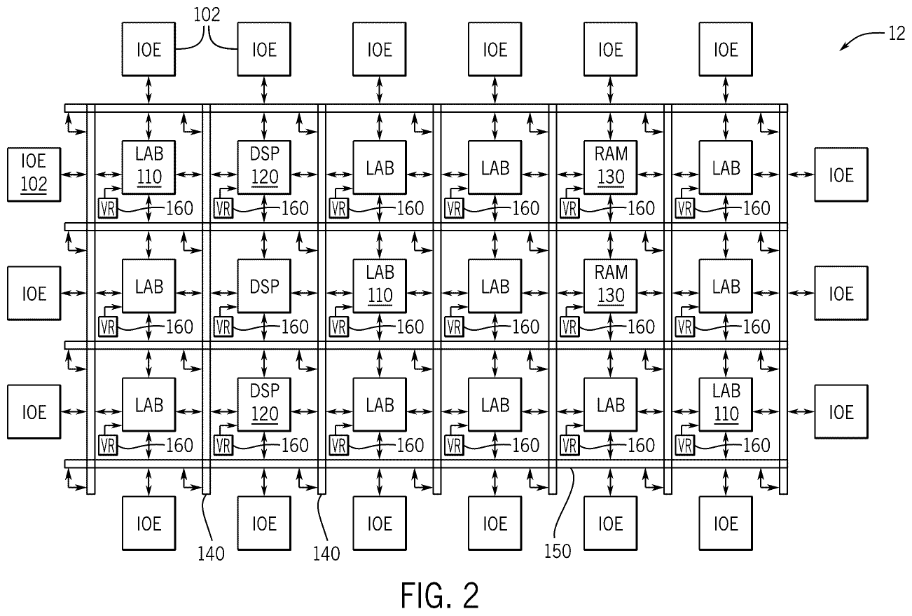

An illustrative embodiment of a programmable integrated circuit device 12 such as a programmable logic device (PLD) (e.g., a field programmable gate array (FPGA) device) that may be configured to implement a circuit design (also sometimes referred to as a system design) is shown in FIG. 2. The integrated circuit device 12 (e.g., a field-programmable gate array (FPGA) integrated circuit device) may include a two-dimensional array of functional blocks sometimes referred to as programmable logic blocks (e.g., also referred to as logic array blocks (LABs) 110 or configurable logic blocks (CLBs)) that may include some number of adaptive logic modules (ALMs) that may be programmed to behave as particular logic circuitry. The integrated circuit device 12 may also include other functional ASIC blocks, such as embedded digital signal processing (DSP) blocks 120 and embedded random-access memory (RAM) blocks 130. Functional blocks such as LABs 110 may include smaller programmable regions (e.g., logic elements, configurable logic blocks, or adaptive logic modules) that receive input signals and perform custom functions on the input signals to produce output signals. LABs 110 may also be grouped into larger programmable regions, sometimes referred to as logic sectors, that are individually managed and configured by corresponding logic sector managers. The grouping of the programmable logic resources on the integrated circuit device 12 into logic sectors, logic array blocks, logic elements, or adaptive logic modules is merely illustrative. In general, the integrated circuit device 12 may include functional logic blocks of any suitable size and type, which may be organized in accordance with any suitable logic resource hierarchy.

Programmable logic circuitry of the integrated circuit device 12 may be controlled by programmable memory elements sometimes referred to as configuration random access memory (CRAM). Memory elements may be loaded with configuration data (also called programming data or a configuration bitstream) using input-output elements (IOEs) 102. Once loaded, the memory elements each provide a corresponding static control signal that controls the operation of an associated functional block (e.g., LABs 110, DSP blocks 120, RAM 130, or IOEs 102).

In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, etc.

The memory elements may use any suitable volatile and/or non-volatile memory structures such as random-access-memory (RAM) cells, fuses, antifuses, programmable read-only-memory (ROM) memory cells, mask-programmed and laser-programmed structures, combinations of these structures, etc. Because the memory elements are loaded with configuration data during programming, the memory elements are sometimes referred to as configuration memory, configuration random-access memory (CRAM), or programmable memory elements. The integrated circuit device 12 (e.g., as a programmable logic device (PLD)) may be configured to implement a custom circuit design. For example, the configuration RAM may be programmed such that LABs 110, DSP blocks 120, and RAM 130, programmable interconnect circuitry (e.g., vertical channels 140 and horizontal channels 150), and the input-output elements 102 form the circuit design implementation. In addition, the programmable logic device may have input-output elements (IOEs) 102 for driving signals off the integrated circuit device 12 and for receiving signals from other devices. Input-output elements 102 may include parallel input-output circuitry, serial data transceiver circuitry, differential receiver and transmitter circuitry, or other circuitry used to connect one integrated circuit to another integrated circuit.

The integrated circuit device 12 may also include local programmable voltage regulators (VRs) 160 that may locally reduce the voltage of a particular circuit block (e.g., LAB 110, DSP block 120, RAM 130, IOE 102) based on a block voltage configuration 21 of the system design configuration 20 that is programmed into the integrated circuit device 12. The programmable VRs 160 may not change the input supply voltage (e.g., Vcc) of the integrated circuit device 12, but rather may take the supply voltage of the integrated circuit device 12 and reduce it for a particular circuit block. For some advanced process nodes, dynamic power consumption is not strictly a linear function of frequency, but also proportional to the square of the voltage. Thus, reducing the voltage provided to different circuit blocks (e.g., LAB 110, DSP block 120, RAM 130, IOE 102) may significantly reduce the total power consumed by the integrated circuit device 12. In general, however, the ASIC blocks of the integrated circuit device 12 (e.g., DSP blocks 120, RAMs 130, cryptographic blocks, blocks specific to artificial intelligence operations, network-on-chip blocks) may be able to operate at a higher frequency than a typical system design. Thus, in practice, reducing the voltage levels of the ASIC blocks of the integrated circuit device 12 may be more likely to provide power savings without otherwise affecting the performance of the system design.

Although FIG. 2 schematically illustrates one programmable VR 160 per circuit block (e.g., LAB 110, DSP block 120, RAM 130, IOE 102), there may be more or fewer programmable VRs 160 than shown. For example, one programmable VR 160 may control a local voltage for a group of DSP blocks 120 or two programmable VRs 160 may supply local voltages for different parts of a single DSP block 120. Moreover, a block voltage configuration 21 of the system design configuration 20 may configure the programmable VRs 160 to all provide the same voltage level for all circuit blocks (e.g., LABs 110, DSP blocks 120, RAMs 130, IOEs 102) or to provide different voltage levels to different circuit blocks (e.g., different voltage levels for different LABs 110, DSP blocks 120, RAMs 130, or IOEs 102). For example, in one particular system design configuration 20, the block voltage configuration 21 may configure one DSP block 120 at a first voltage level and another DSP block 120 at a different second voltage level.

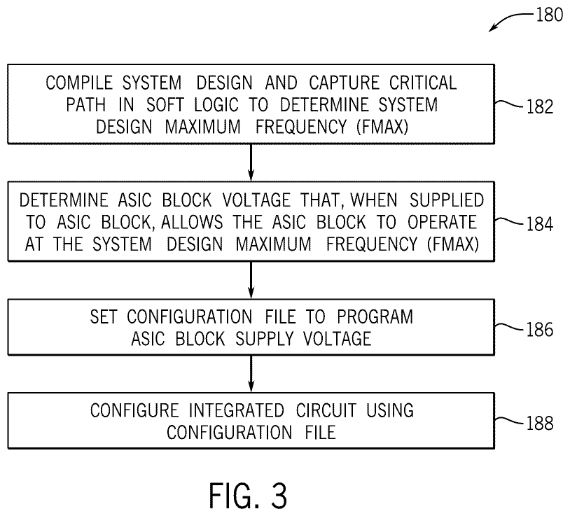

FIG. 3 is a flowchart 180 of a method for efficiently configuring the integrated circuit device 12 with a system design (sometimes also referred to as a circuit design) that adjusts the voltage of the circuit components to save power. Indeed, much of the area of an FPGA core is made up of programmable logic and routing. This is generally sparsely used. Also, although a clock network (and therefore the peak speed) of this logic may reach 1 GHz or more, a typical system design may achieve a much lower operating frequency (e.g., 200 MHz-400 MHz). Modern FPGAs also have many embedded blocks, as noted above. These are not the traditional FPGA soft logic and routing, but ASIC blocks that perform commonly used features that are very expensive (e.g., in terms of performance, area, latency) to implement in soft logic of the programmable logic circuitry of the FPGA. Two common types of these blocks are memory (e.g., RAM 130) and DSP blocks 120. Because these blocks are ASIC blocks, the functionality is very dense, and they can consume significant amounts of power in relation to their area.

To reduce the amount of power consumed by the circuit blocks of the integrated circuit device 12, including ASIC blocks (e.g., DSP blocks 120, RAMs 130, other ASIC blocks such as cryptographic blocks or AI-specific blocks) of the integrated circuit device 12, the design software 14 and/or compiler 16 (e.g., shown in FIG. 1) may configure these blocks to use a lower voltage than the overall supply voltage of the integrated circuit device 12. At process block 182, The design software 14 and/or compiler 16 may develop or receive a system design from a designer and identify its maximum frequency (Fmax) based on its critical path. The system design may include portions that involve soft logic and portions that make use of embedded ASIC blocks. In most system designs, the soft logic portion runs at a fraction of the speed of the embedded ASIC blocks. The critical path is the longest path in terms of signal propagation delay between any two sequential elements (e.g., registers) or between an input and output in the system design. As such, a critical path of the soft logic portion of system design may define the maximum frequency (Fmax) at which the system design may operate when the system design is programmed into the integrated circuit 12.

At the full supply voltage, the ASIC blocks of the integrated circuit device 12 may be capable of operating at a much higher frequency than the maximum frequency (Fmax) of the system design based on the critical path. Therefore, at process block 184, the design software 14 and/or compiler 16 may determine a lower voltage that may be applied to the ASIC blocks of the integrated circuit device 12 while allowing the ASIC blocks to still operate at the maximum frequency (Fmax) of the system design. For example, the design software 14 and/or compiler 16 may use a frequency characterization of the different ASIC blocks of the integrated circuit device 12 that relates the operating frequency of the ASIC blocks at various supply voltage levels. The frequency characterization may take the form of a table or function (e.g., a lookup table in memory of the electronic device 13, a function based on a set of defined variables) based on empirical measurements or computer modeling of the physical voltage-frequency characteristics of the integrated circuit device 12. For instance, different ASIC blocks from different versions of the integrated circuit device 12 (e.g., high-performance versions, lower-cost versions) may have different voltage-frequency characteristics. In some cases, different ASIC blocks within the same version of the integrated circuit device 12 may have different voltage-frequency characteristics. Therefore, the design software 14 and/or compiler 16 may use a frequency characterization appropriate for each ASIC block of the integrated circuit device 12. Thus, in some cases, different voltages may allow different ASIC blocks to operate at the maximum frequency (Fmax) of the system design.

Moreover, different regions of the system design of the integrated circuit device 12 may operate at a different maximum frequency. In cases such as these, a first ASIC block associated with a first region of the system design operating at a first maximum frequency (Fmax1) may be able to use a different voltage level than a second ASIC block associated with a second region of the system design operating at a second maximum frequency (Fmax2), even for the same frequency characterization. The design software 14 and/or compiler 16 may also account for different performance levels associated with the same system design. For instance, if the system design operates at different frequencies at different times (e.g., a lower-power mode and a higher-power mode), the design software 14 and/or compiler 16 may determine the voltage levels that would allow the ASIC blocks to meet the maximum frequencies for those different times.

At block 186, the design software 14 and/or compiler 16 may set the block voltage configuration 21 to include the voltage level(s) of the ASIC blocks in the system design configuration 20 file. At block 188, the integrated circuit device 12 may be programmed using the system design configuration 20. The FPGA configuration of the integrated circuit device 12 may reduce the supply voltage to the ASIC blocks (e.g., DSP blocks 120, RAMs 130, cryptographic blocks, blocks specific to artificial intelligence operations, network-on-chip blocks), providing a substantial power savings without affecting the performance of the integrated circuit device 12.

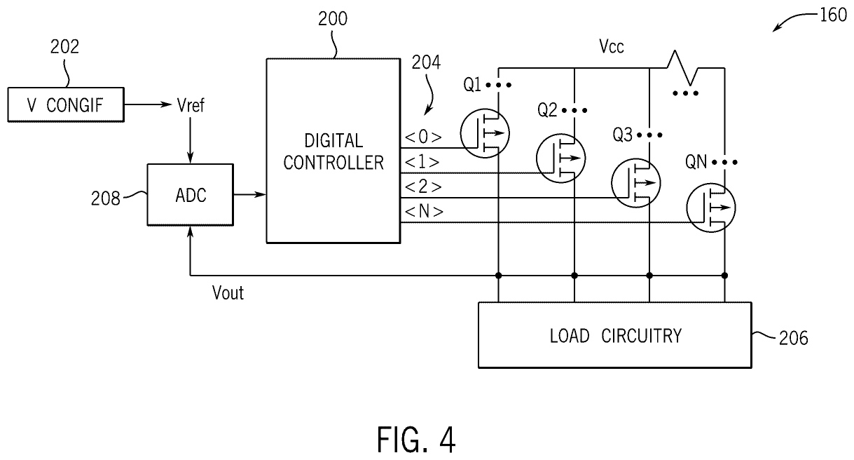

FIG. 4 illustrates a block diagram of a programmable VR 160. The programmable VR 160 may include a digital controller 200 that is configured to provide a reference voltage (Vref) defined by a voltage configuration 202. The voltage configuration 202 may be programmed from the block voltage configuration 21 of the system design configuration 20. The voltage configuration 202 may be programmed into memory (e.g., configuration random access memory (CRAM) of the integrated circuit device 12 or may be read from other memory, which may be stored locally on the integrated circuit device 12 or may be received from a memory device external to the integrated circuit device 12). The voltage configuration 202 may define an absolute voltage level or a relative voltage level (e.g., a proportion) compared to an overall supply voltage (Vcc) (e.g., 95%, 90%, 85%, 50%, 25%). Based on the voltage configuration 202, the reference voltage (Vref) may be generated by any suitable circuitry of the integrated circuit device 12.

The digital controller 200 may include any suitable control circuitry that may generate a control signal 204 (e.g., digital signals <0>, <1>, <2>, . . . , <N>) to selectively activate power transistors Q0 and/or other transistors, Q1 and/or other transistors, Q2 and/or other transistors, . . . , and QN and/or other transistors to control the amount of the overall supply voltage (Vcc) that ultimately reaches load circuitry 206 based on the voltage configuration 202. For example, the digital controller 200 may include a finite state machine (FSM) that is hardened or programmed into soft logic of the programmable logic circuitry. Additionally or alternatively, the digital controller 200 may include a processor or microcontroller that that is hardened or programmed into soft logic of the programmable logic circuitry and which runs software or firmware instructions to control the amount of supply voltage that reaches the load circuitry 206. An analog-to-digital converter (ADC) 208 may receive an output voltage (Vout) as a feedback signal. The output voltage (Vout) represents the voltage being supplied to the load circuitry 206 (e.g., the ASIC block that is being supplied with voltage by the programmable VR 160). The ADC 208 provides a digital feedback signal to the digital controller 200 representing an error between the reference voltage (Vref) and the output voltage (Vout). This error is used by the digital controller 200 to adjusts the digital control signal 204 to increase or decrease the supply voltage so that the output (Vout) is correct based on the voltage configuration 202. To that end, the ADC 208 may be a windowed ADC in some embodiments. The digital controller 200 may increment or decrement the digital control signal 204 to achieve the output voltage (Vout) according to any suitable control scheme. In effect, the digital controller 200 implements a filter with specific transfer function to help compensate for the frequency response of the power transformers of the power train.

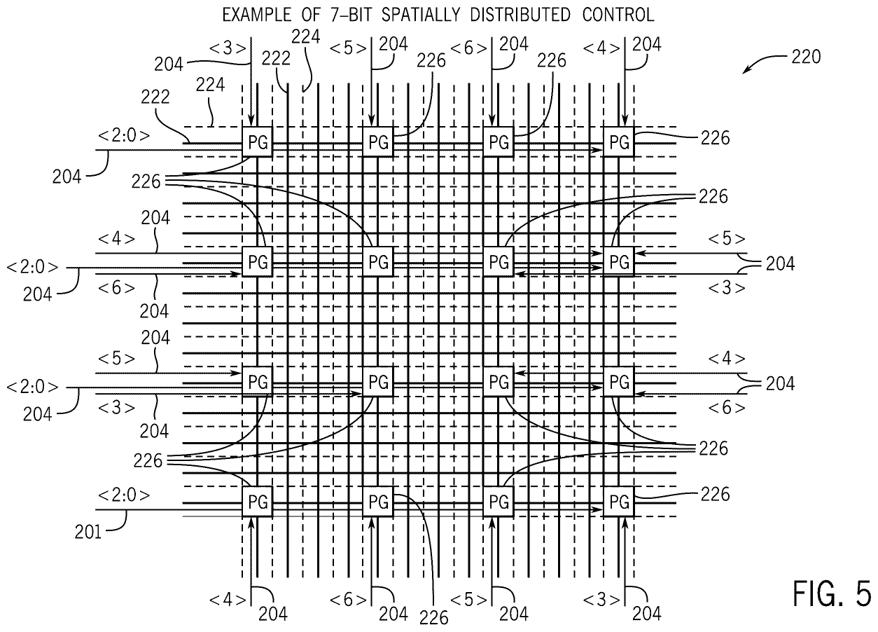

The digital control signal 204 may include any suitable number of control bits and each control bit may control any suitable number of power transistors. FIG. 5 illustrates a power train 220 that receives a 7-bit digital control signal 204 to adjust the voltage level. The power train 220 includes a grid of conductive input power lines 222 at the overall supply voltage level (e.g., Vcc) and conductive output power lines 224 at the output voltage (e.g., Vout). The intersections are connected with the appropriate via structure to create a robust grid. Power switch cells (PGs) 226 are distributed across the grid and selectively pass voltage from the input power lines 222 to the output power lines 224 to achieve the output voltage (Vout). Each power switch cell (PG) 226 may include any suitable number of power transformers and may receive any suitable set of the digital control signal 204. For instance, each power switch cell (PG) 226 may include 100 power transistors, though other embodiments may include more or fewer. Indeed, in practice, the power switch cells (PGs) 226 may have more or fewer power transistors (and may have different numbers of transistors in different spatial locations across the power train 220).

In the example of FIG. 5, all of the power switch cells (PGs) 226 receive control bits <2:0> of the digital control signal 204. These control bits may cause the power switch cells (PGs) 226 to turn on a binary weighted array of power transformers in the power switch cells (PGs) 226. This allows for a uniform distribution of voltage at lower digital control signal 204 levels. Higher-significance control bits of the digital control signal 204 may be distributed spatially to different power switch cells (PGs) 226 and may have a thermometer coding to cause the power switch cells (PGs) 226 to turn on more power transistors. The spatial distribution of the digital control signal 204 may reduce the occurrence of hot spots across the power train 220 as the transistors in the power switch cells (PGs) 226 are turned on and off. While the lower-significance control bits of the digital control signal 204 are described as having a binary coding and the higher-significance control bits of the digital control signal 204 are described as having a thermometer coding, any suitable control coding scheme may be used. Moreover, while FIG. 5 illustrates a spatially distributed 7-bit digital control signal 204, where different power switch cells (PGs) 226 receive different higher-significance control bits, all of the power switch cells (PGs) 226 may receive the same digital control signal 204 in other embodiments.

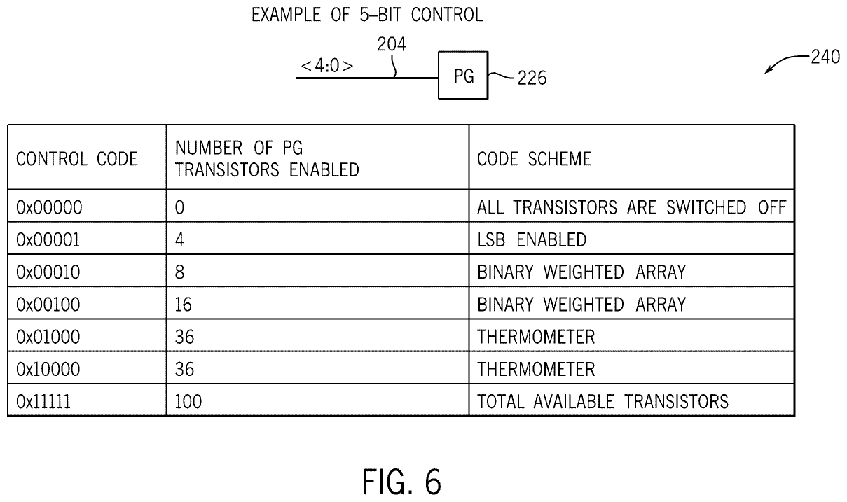

FIG. 6 provides one example of a 5-bit digital control signal 204 that may be used. As mentioned above, the digital control signal 204 may use any suitable number of control bits and may use any suitable form of coding. FIG. 6 represents one such example in which a power switch cell (PG) 226 having 100 power transistors receives a 5-bit digital control signal 204 based on a control coding scheme 240. As mentioned above, this is meant as an example; in other embodiments, the power switch cell (PG) 226 may have more or fewer power transistors and ma use a digital control signal with more or fewer control bits. Returning to the example of FIG. 6, when the 5-bit digital control signal 204 is 0x00000, all of the transistors of the power switch cell (PG) 226 are switched off (e.g., Vout=0). The least significant control bits <2: 0> of the digital control signal 204 may have a binary coding. Thus, a least significant bit 0x00001 of the digital control signal 204 may cause 4 transistors to turn on, a next significant bit 0x00010 of the digital control signal 204 may cause 8 transistors to turn on, and a next significant bit 0x00100 of the digital control signal 204 may cause 16 transistors to turn on. The remaining higher-significance control bits <4:3> of the digital control signal 204 may have a thermometer coding. For example, the control bit <3> (0x01000 ) of the digital control signal 204 may cause 36 transistors to turn on and the control bit <4> (0x10000 ) of the digital control signal 204 may also cause 36 transistors to turn on. In total, when all bits are set in the digital control signal 204 (e.g., 0x11111), all 100 of the transistors of the power switch cell (PG) 226 may be turned on. It should be appreciated that the control coding scheme 240 shown in FIG. 6 is provided by way of example, and that any other suitable control coding scheme for the digital control signal 204 may be used with any suitable number of control bits to control any suitable number of transistors.

The circuits discussed above may be implemented on the integrated circuit device 12, which may be a component included in a data processing system, such as a data processing system 500, shown in FIG. 20. The data processing system 500 may include the integrated circuit device 12 (e.g., a programmable logic device, an application specific integrated circuit (ASIC)), a host processor 502, memory and/or storage circuitry 504, and a network interface 506. The data processing system 500 may include more or fewer components (e.g., electronic display, user interface structures, application specific integrated circuits (ASICs)). Moreover, any of the circuit components depicted in FIG. 20 may include the integrated circuit device 12. The host processor 502 may include any of the foregoing processors that may manage a data processing request for the data processing system 500 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 504 may include random access memory (RAM), read-only memory (ROM), one or more hard drives, flash memory, or the like. The memory and/or storage circuitry 504 may hold data to be processed by the data processing system 500. In some cases, the memory and/or storage circuitry 504 may also store configuration programs (e.g., bitstreams, mapping function) for programming the integrated circuit device 12. The network interface 506 may allow the data processing system 500 to communicate with other electronic devices. The data processing system 500 may include several different packages or may be contained within a single package on a single package substrate. For example, components of the data processing system 500 may be located on several different packages at one location (e.g., a data center) or multiple locations. For instance, components of the data processing system 500 may be located in separate geographic locations or areas, such as cities, states, or countries.

The data processing system 500 may be part of a data center that processes a variety of different requests. For instance, the data processing system 500 may receive a data processing request via the network interface 506 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. To provide only a few examples, these may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

### Example Embodiment 1

An integrated circuit device comprising:
programmable logic circuitry configurable to be set to operate at a first voltage and at a first frequency when configured to implement a system design; and
a first application specific integrated circuit (ASIC) block, embedded among the programmable logic circuitry, configurable to be set to operate at a second frequency equal to or greater than the first frequency at a selectable second voltage different than the first voltage.

### Example Embodiment 2

The integrated circuit device of example embodiment 1, wherein the first ASIC block is configurable to be set to selectably operate at a plurality of selectable voltage levels, wherein the second voltage is selected based upon configuration with a system design configuration file corresponding to the system design.

### Example Embodiment 3

The integrated circuit device of example embodiment 1, wherein the second voltage is lower than an overall supply voltage of the integrated circuit device.

### Example Embodiment 4

The integrated circuit device of example embodiment 1, wherein the second frequency is lower than a maximum frequency of the first ASIC block.

### Example Embodiment 5

The integrated circuit device of example embodiment 1, comprising a second ASIC block embedded among the programmable logic circuitry, wherein the second ASIC block is configurable to be set to operate at the second voltage different than the first voltage.

### Example Embodiment 6

The integrated circuit device of example embodiment 1, comprising a second ASIC block embedded among the programmable logic circuitry, wherein the second ASIC block is configurable to be set to operate at a third voltage different than the first voltage and the second voltage.

### Example Embodiment 7

The integrated circuit device of example embodiment 1, wherein the first ASIC block comprises a digital signal processing (DSP) block comprising hardened arithmetic circuitry.

### Example Embodiment 8

The integrated circuit device of example embodiment 1, wherein the first ASIC block comprises a hardened random-access memory (RAM) block.

### Example Embodiment 9

The integrated circuit device of example embodiment 1, comprising a first programmable voltage regulator associated with the first ASIC block and configurable to supply the second voltage to the first ASIC block.

### Example Embodiment 10

The integrated circuit device of example embodiment 9, wherein the first programmable voltage regulator comprises a digital controller configurable to generate a digital control signal to selectively switch on or off a plurality of power transistors disposed between input conductors supplying the first voltage and output conductors at the second voltage.

### Example Embodiment 11

The integrated circuit device of example embodiment 10, wherein the digital control signal comprises a plurality of control bits having different respective control coding.

### Example Embodiment 12

The integrated circuit of example embodiment 11, wherein a first of the plurality of control bits has a binary control coding and a second of the plurality of control bits has a thermometer control coding.

### Example Embodiment 13

An article of manufacture comprising one or more tangible, non-transitory, machine-readable media comprising instructions that, when executed by a data processing system, cause the data processing system to perform operations comprising:
determining an operating frequency of programmable logic circuitry of a system design for implementation on an integrated circuit device that receives a first supply voltage;
determining a second supply voltage that, when supplied to a first embedded application-specific integrated circuit (ASIC) block in the system design, achieves an operating frequency of the first ASIC block at or above the operating frequency of the programmable logic circuitry, wherein the second supply voltage is lower than the first supply voltage; and
generating a system design configuration that includes a voltage setting based on the second supply voltage.

### Example Embodiment 14

The article of manufacture of example embodiment 13, wherein the operating frequency is determined based on a critical path through the programmable logic circuitry operating at the first supply voltage.

### Example Embodiment 15

The article of manufacture of example embodiment 13, wherein the second supply voltage is determined based on a frequency characterization of the first ASIC block relating supply voltage to operating frequency.

### Example Embodiment 16

The article of manufacture of example embodiment 13, wherein the first supply voltage comprises an overall voltage supply of the integrated circuit device and wherein the voltage setting comprises a proportion of the first supply voltage.

### Example Embodiment 17

The article of manufacture of example embodiment 13, wherein the operations comprise determining a third supply voltage that, when supplied to a second embedded ASIC block in the system design, allows the second ASIC block to operate at or above the operating frequency of the programmable logic circuitry, wherein the third supply voltage is the same as the second supply voltage.

### Example Embodiment 18

The article of manufacture of example embodiment 13, wherein the operations comprise determining a third supply voltage that, when supplied to a second embedded ASIC block in the system design, allows the second ASIC block to operate at or above the operating frequency of the programmable logic circuitry, wherein the third supply voltage is different from the second supply voltage.

### Example Embodiment 19

The article of manufacture of example embodiment 13, wherein the operations comprise configuring the integrated circuit device with the system design configuration, wherein the integrated circuit device comprises a field programmable gate array (FPGA) device.

### Example Embodiment 20

An article of manufacture comprising one or more tangible, non-transitory, machine-readable media comprising a system design configuration of an integrated circuit device that comprises supply voltage settings that define a first supply voltage for a first embedded application specific integrated circuit (ASIC) block of an integrated circuit device that is lower than an overall supply voltage of the integrated circuit device that is supplied to field programmable gate array (FPGA) soft logic circuitry of the integrated circuit device.

What is claimed is:

1. An integrated circuit device comprising:
programmable logic circuitry configurable to be set to operate at a first voltage and at a first frequency when configured to implement a system design; and
a first application specific integrated circuit (ASIC) block, embedded among the programmable logic circuitry, configurable to be set to operate at a second frequency equal to or greater than the first frequency at a selectable second voltage different than the first voltage.

2. The integrated circuit device of claim 1, wherein the first ASIC block is configurable to be set to selectably operate at a plurality of selectable voltage levels, wherein the second voltage is selected based upon configuration with a system design configuration file corresponding to the system design.

3. The integrated circuit device of claim 1, wherein the second voltage is lower than an overall supply voltage of the integrated circuit device.

4. The integrated circuit device of claim 1, wherein the second frequency is lower than a maximum frequency of the first ASIC block.

5. The integrated circuit device of claim 1, comprising a second ASIC block embedded among the programmable logic circuitry, wherein the second ASIC block is configurable to be set to operate at the second voltage different than the first voltage.

6. The integrated circuit device of claim 1, comprising a second ASIC block embedded among the programmable logic circuitry, wherein the second ASIC block is configurable to be set to operate at a third voltage different than the first voltage and the second voltage.

7. The integrated circuit device of claim 1, wherein the first ASIC block comprises a digital signal processing (DSP) block comprising hardened arithmetic circuitry.

8. The integrated circuit device of claim 1, wherein the first ASIC block comprises a hardened random-access memory (RAM) block.

9. The integrated circuit device of claim 1, comprising a first programmable voltage regulator associated with the first ASIC block and configurable to supply the second voltage to the first ASIC block.

10. The integrated circuit device of claim 9, wherein the first programmable voltage regulator comprises a digital controller configurable to generate a digital control signal to selectively switch on or off a plurality of power transistors disposed between input conductors supplying the first voltage and output conductors at the second voltage.

11. The integrated circuit device of claim 10, wherein the digital control signal comprises a plurality of control bits having different respective control coding.

12. The integrated circuit device of claim 11, wherein a first of the plurality of control bits has a binary control coding and a second of the plurality of control bits has a thermometer control coding.

13. An article of manufacture comprising one or more tangible, non-transitory, machine-readable media comprising instructions that, when executed by a data processing system, cause the data processing system to perform operations comprising:
determining an operating frequency of programmable logic circuitry of a system design for implementation on an integrated circuit device that receives a first supply voltage;
determining a second supply voltage that, when supplied to a first embedded application-specific integrated circuit (ASIC) block in the system design, achieves an operating frequency of the first ASIC block at or above the operating frequency of the programmable logic circuitry, wherein the second supply voltage is lower than the first supply voltage; and
generating a system design configuration that includes a voltage setting based on the second supply voltage.

14. The article of manufacture of claim 13, wherein the operating frequency is determined based on a critical path through the programmable logic circuitry operating at the first supply voltage.

15. The article of manufacture of claim 13, wherein the second supply voltage is determined based on a frequency characterization of the first ASIC block relating supply voltage to operating frequency.

16. The article of manufacture of claim 13, wherein the first supply voltage comprises an overall voltage supply of the integrated circuit device and wherein the voltage setting comprises a proportion of the first supply voltage.

17. The article of manufacture of claim 13, wherein the operations comprise determining a third supply voltage that, when supplied to a second embedded ASIC block in the system design, allows the second ASIC block to operate at or above the operating frequency of the programmable logic circuitry, wherein the third supply voltage is the same as the second supply voltage.

18. The article of manufacture of claim 13, wherein the operations comprise determining a third supply voltage that, when supplied to a second embedded ASIC block in the system design, allows the second ASIC block to operate at or above the operating frequency of the programmable logic circuitry, wherein the third supply voltage is different from the second supply voltage.

19. The article of manufacture of claim 13, wherein the operations comprise configuring the integrated circuit device with the system design configuration, wherein the integrated circuit device comprises a field programmable gate array (FPGA) device.

20. An article of manufacture comprising one or more tangible, non-transitory, machine-readable media comprising a system design configuration of an integrated circuit device that comprises supply voltage settings that define a first supply voltage for a first embedded application specific integrated circuit (ASIC) block of an integrated circuit device that is lower than an overall supply voltage of the integrated circuit device that is supplied to field programmable gate array (FPGA) soft logic circuitry of the integrated circuit device.
